(19) United States
(12) Patent Application Publication
(10) Pub. No.: US 2014/0115378 A1
(43) Pub. Date: Apr. 24, 2014

(54) SYSTEM AND METHOD FOR RESTORING NETWORK CONFIGURATION PARAMETERS

(71) Applicants: CAL-COMP ELECTRONICS & COMMUNICATIONS COMPANY LIMITED, New Taipei City (TW); KINPO ELECTRONICS, INC., New Taipei City (TW)

(72) Inventors: Chin-Yu Chin, New Taipei City (TW); Yu-Yang Chang, New Taipei City (TW); Hsiang-Hung Hsieh, New Taipei City (TW)

(73) Assignees: Kinpo Electronics, Inc., New Taipei City (TW); Cal-Comp Electronics & Communications Company Limited, New Taipei City (TW)

(21) Appl. No.: 13/792,235

(22) Filed: Mar. 11, 2013

(30) Foreign Application Priority Data
Oct. 24, 2012 (TW) 101139310

(51) Int. Cl. G06F 11/07

(52) U.S. Cl. CPC G06F 11/0709
USPC 714/4.3

(57) ABSTRACT

A system and a method for restoring network configuration parameters suitably adapted for automatically restoring the network configuration parameters to the ones before a power failure are provided. The method includes the following steps. A system chipset pre-stores network configuration parameters corresponding to a network unit. The system chipset executes a U-boot procedure when the power supply restores. Then the system chipset detects a status flag of the network unit. When the status flag is false, the system chipset writes the network configuration parameters into the network unit and sets the status flag to true. Then, the system chipset executes a shut-down procedure.

### CROSS-REFERENCE TO RELATED APPLICATION

This application claims the priority benefit of Taiwan application serial no. 101139310, filed on Oct. 24, 2012. The entirety of the above-mentioned patent application is hereby incorporated by reference herein and made a part of this specification.

### BACKGROUND OF THE INVENTION

1. Field of the Invention

The present invention generally relates to a system and a method for restoring network configuration parameters, in particular, to a system and a method which automatically turn on a system power source and restore network configuration parameters by determining a status flag of a network unit after a power supply fails and recovers.

2. Description of Related Art

Network communication products have gained much popularity nowadays, wherein a Wake on Local Area Network (Wake on LAN) has become one of the main features. However, the feature of the Wake on LAN may not be turned on by default. The default configuration of the parameters is off and may only be turned on after a power source completes the configuration upon connection. In terms of the physical architecture of a network interface unit, configuration parameters of the LAN are not able to be preserved after a power failure. Due to a standby power source disposed on the network interface unit, the configuration parameters may not need to reconfigure after every reboot. However, in such method, if it comes to a power failure followed by a recovery, a network equipment may re-read the default parameters configured upon manufacture so that the turned on Wake on LAN configuration parameters returns to the turned off status configured upon manufacture. Therefore, a user is not able to connect to a local electronic device via an external network by Wake on LAN. To solve a problem which the configuration parameters of the Wake on LAN is unable to be stored, there exists a prior art such that the LAN configuration parameters are stored into a System-On-a-Chip (SOC), and the stored Wake on LAN configuration parameter is configured directly in the network interface unit upon reboot. However, in such method, the parameters of the network interface unit before the power failure are unknown and then the parameters stored in the SOC may be returned. Moreover, there exists another prior art such that a Micro Control Unit (MCU) is externally connected to the network interface unit and the feature of the Wake on LAN is dominated by the MCU. However, in such method, the cost may increase due to the disposition of the MCU, and the power exhaustion of the standby power source may increase as well.

### SUMMARY OF THE INVENTION

Due to the shortcomings of the prior art, a system for recovering network configuration parameters adapted for recovering network configuration parameters to the ones before a power failure when a power supply module fails and recovers is provided in the present invention. Such system for recovering network configuration parameters includes a network unit and a system chipset. The network unit is connected to the power supply module via a standby power supply module. The network unit includes a status flag. When the status flag is true, the network configuration parameters are viewed as being written into the network unit. When the status flag is false, the network configuration parameters are viewed as not being written into the network unit. The system is coupled to the network unit and connected to the power supply module via a system power circuit. The system chipset includes a memory and a control unit, wherein the memory stores the network configuration parameters corresponding to the network unit. The control unit is coupled to the memory. When the power supply module recovers, the system power circuit is enabled. The control unit executes a U-boot procedure and then detects the status flag of the network unit. When the status flag is false, the network configuration parameters are written into the network unit, and the status flag is set to true. Then a shut-down procedure is executed.

According to an embodiment and other embodiments of the present invention, a method for recovering network configuration parameters adapted for recovering network configuration parameters of a network unit to the ones before a power failure by a system chipset when the power supply module fails and recovers is provided in the present invention. The network unit is connected to the power supply module via a standby power circuit. The network unit includes a status flag. When the status flag is true, the network configuration parameters are viewed as being written into the network unit. When the status flag is false, the network configuration parameters are viewed as not being written into the network unit. The system chipset is connected to the power supply module via a system power circuit. The method for recovering network configuration parameters includes the following steps. The network configuration parameters corresponding to the network unit are pre-stored into the system chipset. When the power supply module recovers, the system power circuit is enabled, and the system chipset executes a U-boot procedure. The system chipset detects the status flag of the network unit. When the status flag is false, the system chipset writes the network configuration parameters into the network unit. The system chipset sets the status flag to true. Then, the system chipset executes a shut-down procedure.

Based on the above descriptions, a system and a method for recovering network configuration parameters are provided in the present invention. Such method pre-stores the network configuration parameters into a memory of a system chipset. When a power supply module fails and recovers, a system power is able to be turned on, and the network configuration parameters stored in the memory are automatically configured into a network unit.

Several exemplary embodiments accompanied with figures are described in detail below to further describe the disclosure in details.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a functional block diagram of a system for restoring network configuration parameters according to an embodiment of the present invention.

FIG. 2 is a flow diagram of a method for restoring network configuration parameters according to an embodiment of the present invention.

### DESCRIPTION OF THE EMBODIMENTS

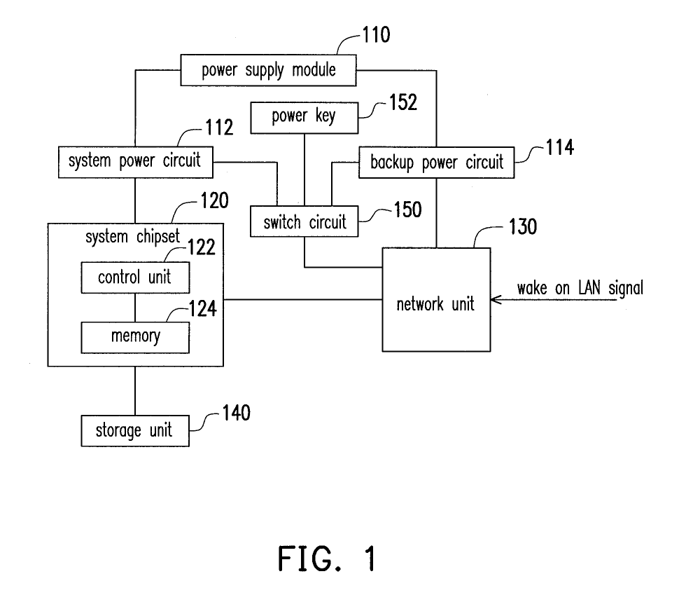

FIG. 1 is a functional block diagram of a system for restoring network configuration parameters according to an embodiment of the present invention. When a public electricity supply fails and recovers, such system is suitably adapted for automatically restoring network configuration parameters to the ones before the power failure. The system for restoring network configuration parameters includes a system chipset 120 and a network unit 130, wherein the network unit 130 is connected to a power supply module 110 via a standby power circuit 114 and includes a status flag. When the status flag is true, the network configuration parameters are viewed as already being written into the network unit 130. When the status flag is false, the network configuration parameters are viewed as not being written into the network unit 130. The network unit 130 may be a combination of a wired network connector (eg. RJ-45) and a wired network interface card which support a wired network. The network unit 130 may also be a wireless interface unit which supports a wireless network. The system chipset 120 is coupled to the network unit 130. The system chipset 120 is also connected to the power supply module 110 via a system power circuit 112. Moreover, the system for restoring network configuration parameters further includes a storage unit 140, wherein the storage unit 140 is coupled to the system chipset 120 adapted for storing data information and files. Through the management of a control unit 122, such data information and files may be received by an external network via the network unit 130.

However, when the power supply module 110 fails, the system power circuit 112 and the standby power circuit 114 may lead to losses in electricity supply and further cause the system chipset 120 and the network unit 130 to stop working.

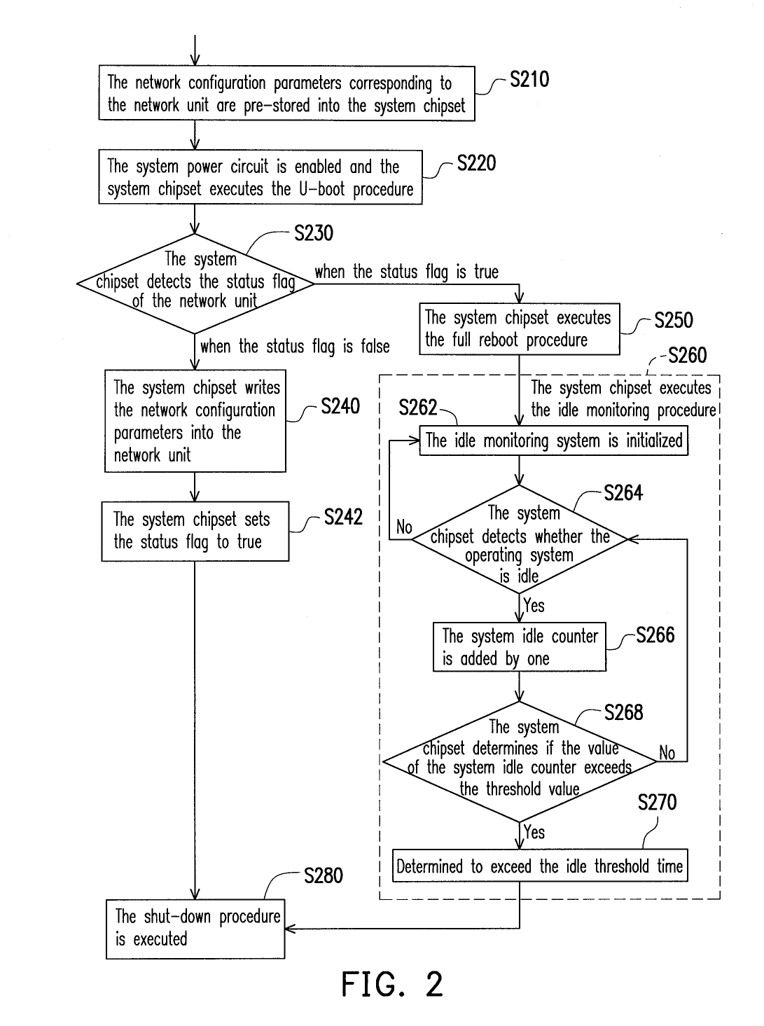

To solve the problem caused by a power failure, the system chipset 120 provided by an embodiment of the present invention includes the control unit 122 and a memory 124. The memory 124 stores the network configuration parameters corresponding to the network unit 130, and the control unit 122 is coupled to the memory 124. When the power supply module 110 recovers, the system power circuit 112 is enabled, and the control unit 122 executes a U-boot procedure and writes the network configuration parameters into the network unit 130. Detailed steps of the present invention will be described hereinafter along with a flow diagram of a method for restoring network configuration parameters illustrated in FIG. 2. Please refer to both FIG. 1 and FIG. 2.

FIG. 2 is a flow diagram of a method for restoring network configuration parameters according to an embodiment of the present invention. First, the control unit 122 pre-stores the network configuration parameters corresponding to the network unit 130 into the memory 124 of the system chipset 120 (Step S210). Then, when the power supply module 110 recovers from the power failure, the system power circuit 112 is enabled, and the system chipset 120 of the control system 122 to executes the U-Boot procedure (Step S220). Then the control unit 122 detects the status flag of the network unit 130 (Step S230). When the status flag is false, it represents that the network configuration parameters have not yet been written into the network unit 130. Meanwhile, the control unit 122 writes the network configuration parameters into the network unit 130 (Step S240). The status flag of the network unit 130 is then set to true (Step S242). Lastly, a shut-down procedure is executed (Step S280), wherein the shut-down procedure includes disabling the system power circuit 112 by the control unit 122 and keeping the enabling status of the standby power circuit 114.

In other words, when the power supply module 110 fails, the network configuration parameters are erased. The system for recovering network configuration parameters provided by the present invention executes the U-boot procedure after the power supply module 110 recovers. Based on the network configuration parameters pre-stored into the memory 124, after the status flag of the network unit 130 is determined to be false, the system extracts the network configuration parameters in the memory and immediately configures those into the network unit 130. Through this approach, it may prevent a user from operating inconvenience caused by a loss of network configuration parameters. After the configuration is completed, the system executes the shut-down procedure for power saving.

The condition as described above is when the power supply module 110 fails and recovers. However, there exist other conditions which enable the system power circuit 112 in the embodiment of the present invention. A switch circuit 150 as illustrated in FIG. 1 is coupled to the standby power circuit 114, the system power circuit 112, the network unit 130, and a power key 152. When the power supply module 110 is operating in a normal condition, and when the switch circuit 150 receives a Wake on LAN signal via the network unit 130, the switch circuit 150 enables the system power circuit 112. Additionally, when the switch circuit 150 detects the power key 152 being pressed, the switch circuit 150 enables the system power circuit 112 as well.

When the power supply module 110 is operating in the normal condition without any loss of the network configuration parameters, after the switch circuit 150 receives the Wake on LAN signal via the network unit 130 or detects the power key 152 being pressed and further enables the system power circuit 112, the control unit 112 executes the U-boot procedure (Step S220). Then, the control unit 112 detects the status flag of the network unit (Step S230). When the status flag is determined to be true in Step S230, it represents that the configuration of the network configuration parameters is completed, and the control unit 122 then executes a full reboot procedure (Step S250). Such full reboot procedure includes executing a Kernel and file system program. Then the control unit 122 executes an idle monitoring procedure (Step S260). Such idle monitoring procedure includes the following steps S262-S260. Please refer to the description hereinafter.

First, the control unit 122 initializes an idle monitoring program (Step S262), wherein the idle monitoring program includes a system idle counter. Then the idle monitoring program monitors whether an operating system operating on the system chip 120 is idle (Step S264). If Step S264 is determined to be false, then return to Step S262 and reinitializes the idle monitoring program. If Step S264 is determined to be true, then the control unit 122 adds one to the system idle counter (Step S266). Then, the control unit 122 determines whether the system idle counter exceeds a threshold value (Step S268). If Step S268 is determined to be false, then return to Step S264 and continue monitoring whether the operating system is idle. If Step S268 is determined to be true, an idle time of the operating system is determined to exceed an idle threshold time (Step S270) and the shut-down procedure is then executed (Step S280).

In view of the foregoing, a system and a method for recovering network configuration parameters are provided in the present invention. Such method pre-stores the network configuration parameters into a memory of a system chipset. When a power supply module fails and recovers, a system power is able to be turned on, and the network configuration parameters stored in the memory are automatically configured into a network unit. Based on the above, since any inconvenience from a loss of the network configuration may be prevented from a power failure, a user is able to execute a Wake on LAN according to the network configuration prior to the power failure and further performs functions such as data search or file extraction by connecting to a local network device via an external network.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A system for recovering network configuration parameters, adapted for recovering network configuration parameters to the ones before a power failure when a power supply module fails and recovers, wherein the system for recovering network configuration parameters comprises a network unit and a system chipset, wherein the network unit is connected to the power supply module via a standby power circuit and comprises a status flag, wherein the network configuration parameters are viewed as being written into the network unit when the status flag is true, wherein the network configuration parameters are viewed as not being written into the network unit when the status flag is false, wherein the system chipset is coupled to the network unit and connected to the power supply module via a system power circuit, wherein the system chipset comprises:
a memory storing the network configuration parameters corresponding to the network unit; and
a control unit coupled to the memory, wherein the system power circuit is enabled when the power supply module recovers, wherein the control unit executes a U-boot procedure, then wherein the control unit detects the status flag of the network unit, wherein the network configuration parameters are written into the network unit when the status flag is false, then wherein the status flag is set to true and a shut-down procedure is executed.

2. The system for recovering network configuration parameters according to claim 1, wherein the shut-down procedure comprises enabling the system power circuit by the control unit and keeping an enabling status of the standby power circuit.

3. The system for recovering network configuration parameters according to claim 1 further comprising:
a switch circuit coupled to the standby power circuit, the system power circuit, and the network unit, wherein the switch circuit enables the system power circuit when the switch circuit receives the Wake on Local Area Network (LAN) signal.

4. The system for recovering network configuration parameters according to claim 3 further comprising the switch circuit coupled to a power key, wherein the switch circuit enables the system power circuit when the switch circuit detects the power key being pressed.

5. The system for recovering network configuration parameters according to claim 4 further comprising:
executing a full reboot procedure by the control unit when the control unit detects the status flag of the network unit to be true, wherein the full reboot procedure comprises executing a Kernel and file system program.

6. The system for recovering network configuration parameters according to claim 5 further comprising executing an idle monitoring procedure by the control unit after a full reboot procedure is completed.

7. The system for recovering network configuration parameters according to claim 6, wherein the idle monitoring procedure comprises initializing an idle monitoring program by the control unit, wherein the idle monitoring program comprises a system idle counter and then detects if an operating system operating on the system chipset is idle, wherein the system idle counter is added by one if the operating system is determined to be idle, then wherein the system idle counters is determined whether it exceeds a threshold value, wherein if the threshold value is exceeded, then an idle time of the operating system is determined to exceed an idle threshold time.

8. The system for recovering network configuration parameters according to claim 7 further comprising reinitializing the idle monitoring program when the control unit determines the operating system not to be idle.

9. The system for recovering network configuration parameters according to claim 7 further comprising determining the system idle counter not to exceed the idle threshold time and continuing detecting whether the operating system operating on the system chipset is idle when the system idle counter is determined not to exceed the threshold value by the control unit.

10. The system for recovering network configuration parameters according to claim 7 further comprising executing the shut-down procedure by the control unit when the idle time of the operating system is determined to exceed the idle threshold time.

11. A method for recovering network configuration parameters, suitably adapted for recovering network configuration parameters of a network unit to the ones before a power failure by a system chipset when a power supply module fails and recovers, wherein the network unit is connected to the power supply module via a standby power circuit and comprises a status flag, wherein the network configuration parameters are viewed as being written into the network unit when the status flag is true, wherein the network configuration parameters are viewed as not being written into the network unit when the status flag is false, wherein the system chipset is connected to the power supply module via a system power circuit, wherein the method comprises:
pre-storing the network configuration parameters corresponding to the network unit into the system chipset;
enabling the system power circuit and executing a U-book procedure by the system chipset when the power supply module recovers;
detecting the status flag of the network unit by the system chipset;
writing the network configuration parameters into the network unit by the system chipset when the status flag is false;
setting the status flag to true by the system chipset; and
executing a shut-down procedure by the system chipset.

12. The method for recovering network configuration parameters of claim 11, wherein the shut-down procedure comprises:
disabling the system power circuit; and
keeping an enabling status of the standby power circuit.

13. The method for recovering network configuration parameters of claim 11 further comprising:
detecting a Wake on LAN signal by a switch circuit and enabling the system power circuit by the switch circuit when the switch circuit receives the Wake on LAN signal via the network unit.

14. The method for recovering network configuration parameters of claim 13 further comprising:
enabling the system power circuit by the switch circuit when the switch circuit detects a power switch being pressed.

15. The method for recovering network configuration parameters of claim 14 further comprising:
executing a full reboot procedure by the system chipset when the status flag of the network unit is true, wherein the full reboot procedure comprises executing a Kernel and file system program.

16. The method for recovering network configuration parameters of claim 15 further comprising:
executing an idle monitoring procedure by the system chipset after the full reboot procedure is completed.

17. The method for recovering network configuration parameters of claim 16, wherein the idle monitoring procedure comprises:
initializing an idle monitoring program, wherein the idle monitoring program comprises a system idle counter;
detecting whether the operating system is idle by the system chipset;
adding one to the system idle counter if the operating system is determined to be idle;
determining whether the system idle counter exceeds a threshold value by the system chipset;
determining an idle time of the operating system to exceed an idle threshold time if the system idle counter is determined to exceed the threshold value.

18. The method for recovering network configuration parameters of claim 17 further comprising:
determining the operating system not to be idle and then reinitializing the idle monitoring program when the system chipset determines the system idle counter not to exceed the threshold value.

19. The method for recovering network configuration parameters of claim 17 further comprising:
determining the idle time of the operating system not to exceed the idle threshold time when the system chipset determines the system idle counter not to exceed the threshold value; and
continuing detecting whether the operating system is idle by the system chipset.

20. The method for recovering network configuration parameters of claim 17 further comprising:
executing the shut-down procedure when the system chipset is determined to exceed the idle threshold time.
